(19) United States
(12) Patent Application Publication
(10) Pub. No.: US 2005/0216634 A1
(43) Pub. Date: Sep. 29, 2005

(54) Method for remote control of computer system

(76) Inventors: Tung-Peng Wu, Taipei (TW); Chi-Min Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/060,439

(22) Filed: Feb. 18, 2005

(30) Foreign Application Priority Data
Feb. 20, 2004 (TW) 093104379

(51) Int. Cl. G06F 13/24

(52) U.S. Cl. 710/260

(57) ABSTRACT

A method for remote control of a computer system is disclosed. By pressing buttons of a remote controller, a computer system in remote end is operated. When users in remote end press buttons for transmitting signals, a receiving unit of the computer system receives the signals. Then the receiving unit sends a first signal to a chip unit for transmitting a second signal to a central processing unit so as to make the central processing unit stop current work temporarily and run a service program for initiating a multimedia player system mode or other modes.

### BACKGROUND OF THE INVENTION

The present invention relates to a method for remote control of a computer system, especially to an interrupt technology of computer system by which users can control the computer system in remote end to run a multimedia player system mode or other operating system modes.

By the fast development of the technology nowadays, the computer system has more powerful functions. Besides word processing such as data processing, wireless data transmission, internet and facsimile, computers offer multimedia entertainment, integrating entertainment with the data processing function. Thus the computer has become an essential tool for people. Moreover, the computer system is able to combine with a remote controller so as to make users sit in sofas after work and operate multimedia application programs, watch films or listen to music with computer systems remotely, just like remote control of audio equipments and televisions. The users only need to press buttons and point the remote controller at the computer. It's easy and convenient in operation.

Most of the remote controllers for computer systems available now are used in combination with keyboard encoders for running application programs in computer systems. That is when users press the remote controllers for transmitting signals, the receiver in the computer receives the signals and sends them to the keyboard encoder for coding. Then the encoder will send the make code (scan code) to the computer system for decoding and running corresponding functions. The process is quite complicated.

Thus there is a need to provide a method for remote control of a computer system that uses a remote controller in combination with an interrupt technology of computer systems to finish the above process, without through the processing of the keyboard encoder.

### SUMMARY OF THE INVENTION

It is therefore a primary object of the present invention to provide a method for remote control of a computer system that uses interrupt technology of computer systems, without through the processing of the keyboard encoder to control the computer system for executing commands. It's an easy and convenient way for users to operate computers.

A method for remote control of a computer system in accordance with the present invention is disclosed. When users press buttons on a remote controller, a remote signal is transmitted. A receiving unit of the computer system receives the remote signal and sends a first signal to a chip unit. After receiving the first signal, the chip unit sends a second signal to a central processing unit of the computer system so as to make the central processing unit halt the current programs temporarily by causing an interrupt. At last, a service program is executed to initiate or run the multimedia player system mode or an operating system mode with lower system resource consumption that corresponds to the buttons being pressed by users.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a computer system in accordance with the present invention;

FIG. 2 is a flow chart of an embodiment in accordance with the present invention;

FIG. 3 is a flow chart of another embodiment in accordance with the present invention.

### DETAILED DESCRIPTION OF THE PREFFERED EMBODIMENT

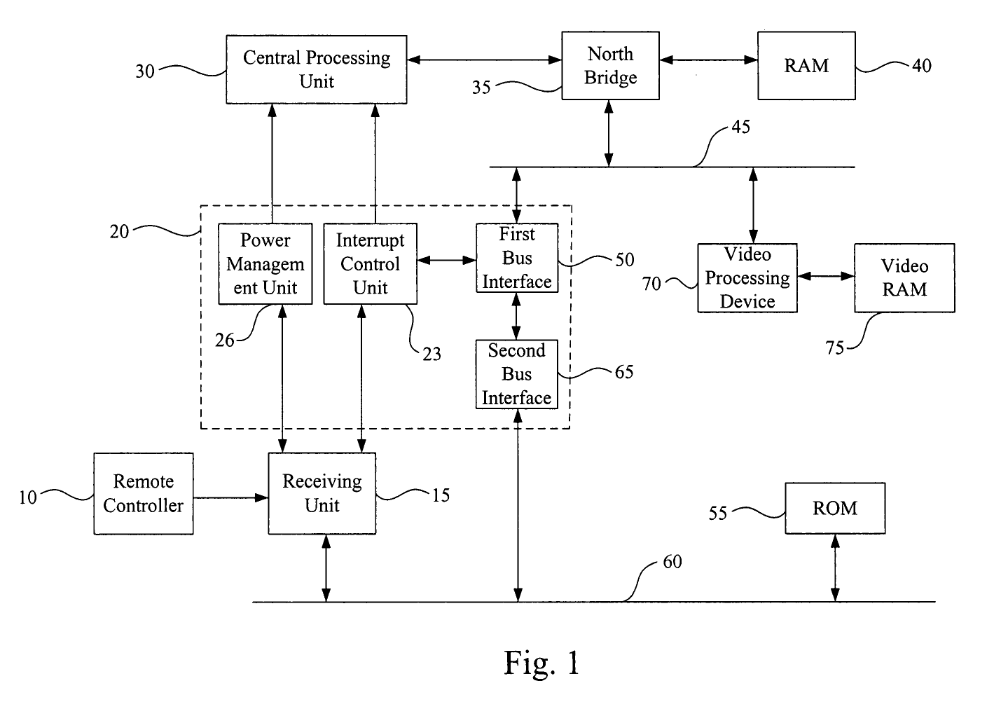

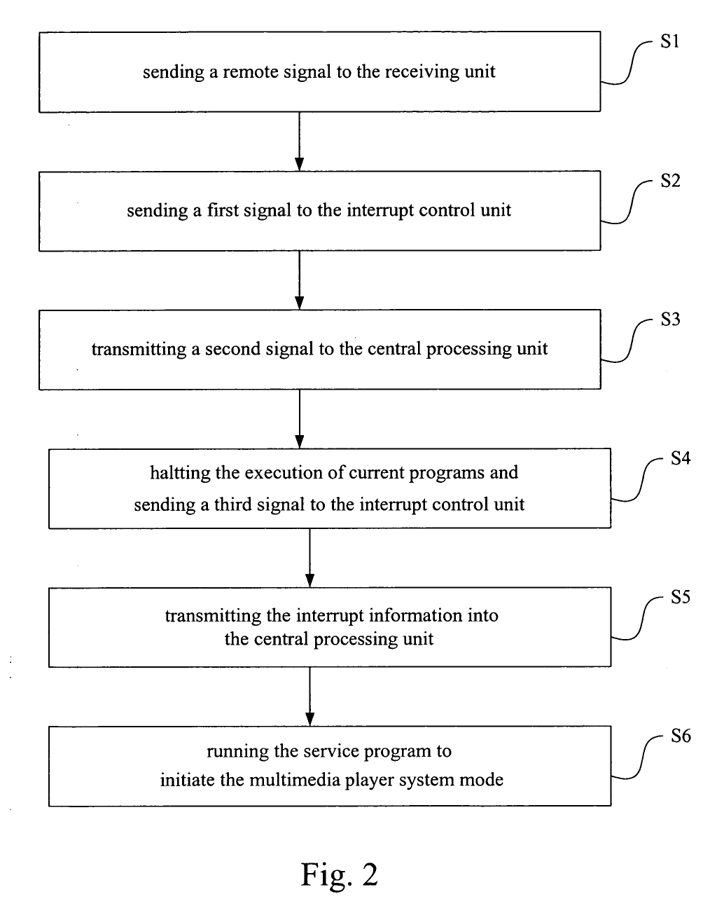

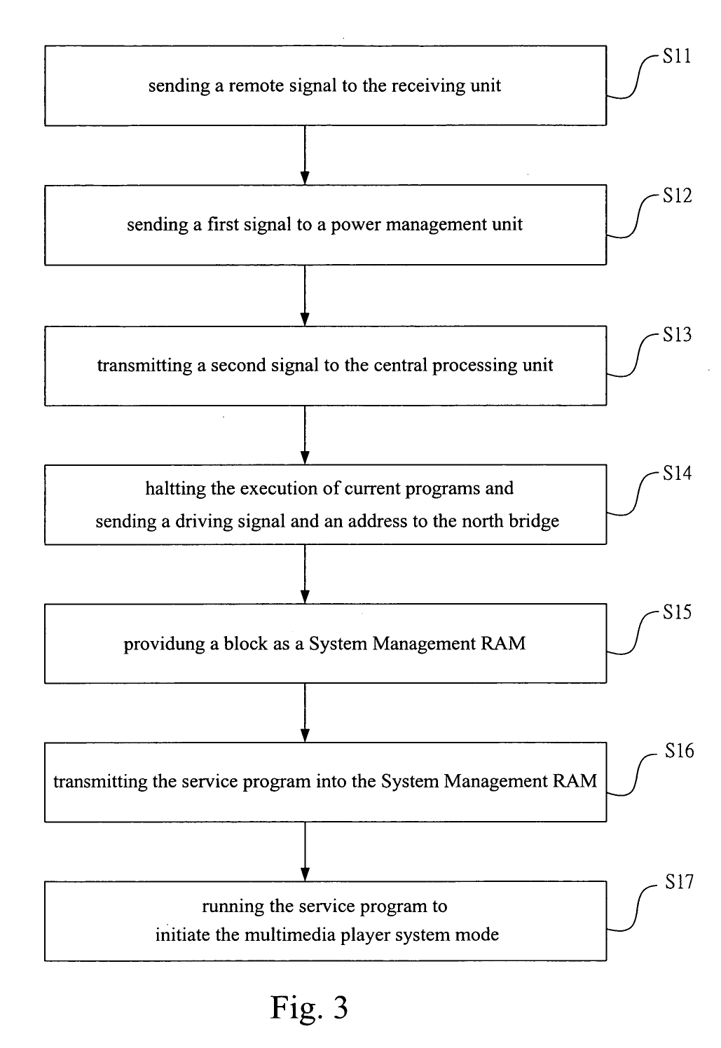

Refer to FIG. 1 & FIG. 2, a block diagram and a flow chart of a computer system in accordance with the present invention are disclosed. The computer system includes an operating system mode and a multimedia player system mode. When the computer system is turned on, the operating system mode is initiated while the multimedia player system mode is used to play MPEG-1 Audio Layer 3 (MP3) music, compact disk (CD), digital versatile disc (DVD), Video Compact Disc (VCD), TV programs, and broadcasting. Under the operating system mode of the computer system, when users press buttons on a remote controller 10 to initiate the multimedia player system mode, the remote controller 10 sends a remote signal to a receiving unit 15. Then the receiving unit 15 transmits a first signal to a chip unit, which is a south bridge 20, for producing an interrupt of the computer system. The first signal is an electrical signal. Because the interrupt mode of the computer system can be Interrupt Request (IRQ) mode or System Management Interrupt (SMI) mode, the first signal can be an interrupt request signal or a system management interrupt signal. The flow chart shown in FIG. 2 demonstrates the processing procedure when the interrupt mode of the computer system is the Interrupt Request mode while the flow chart in FIG. 3 shows the processing procedure when the interrupt mode of the computer system is the System Management Interrupt mode.

Refer to FIG. 2, as shown in step S1, when users press the button, the remote controller 10 in remote end sends a remote signal to the receiving unit 15. Then refer to step S2, after receiving the remote signal, the receiving unit 15 sends a first signal (an interrupt request signal) to an interrupt control unit 23 of the south bridge 20. Then as shown in step S3, the interrupt control unit 23 receives the interrupt request signal and transmits a second signal to a central processing unit 30. The second signal is an interrupt signal for processing interrupt. Refer to step S4, the central processing unit 30 halts the execution of current programs and through a north bridge 35, stores all information in registers on a storage medium such as Random Access Memory (RAM) 40. The central processing unit 30 also sends a third signal, passing through the north bridge 35, a first bus 45, and a first bus interface 50 in sequence, back to the interrupt control unit 23. The third signal is a reply signal from the central processing unit 30 for response to the interrupt control unit 23.

Then refer to step S5, after receiving the reply signal, the interrupt control unit 23 transmits the interrupt information into the central processing unit 30 through the first bus interface 50, the first bus 45, and the north bridge 35 in sequence. The interrupt information is data inside an interrupt vector table, being retrieved by the interrupt control unit 23 according to the received interrupt request signal. The interrupt information is associated with addresses of service programs initiated by pressing buttons. The interrupt vector table is a table containing addresses of programs that handle interrupts and is stored in a basic input output system in read only memory (ROM) 55 of the computer system. When the computer is booted up, the interrupt vector table is read and stored in the RAM 40 for retrieving data while receiving interrupt request signals. The transmission of the interrupt vector table from the ROM 55 to the RAM 40 is through a second bus 60, a second bus interface 65, the first bus interface 50, the first bus 45 and the north bridge 35.

As shown in step S6, according to the received address, the central processing unit 30 run the service program corresponding to the interrupt request signal in RAM 40 so as to initiate the multimedia player system mode for playing MPEG-1 Audio Layer 3 (MP3) music, compact disk (CD), digital versatile disc (DVD), Video Compact Disc (VCD), TV programs, and broadcasting.

Refer to FIG. 3, step S11, under the operating system mode of the computer system, when users press buttons on a remote controller 10 to initiate the multimedia player system mode, the remote controller 10 transmits a remote signal to a receiving unit 15. After receiving the remote signal, as shown in step S12, the receiving unit 15 sends a first signal to a power management unit 26 of a south bridge 20. The first signal is a system management interrupt signal. Refer to step S13, then the power management unit 26 sends a second signal that is an interrupt signal to a central processing unit 30 after receiving the system management interrupt signal. As shown in step S14, when the interrupt signal is received, the central processing unit 30 halts the execution of current programs and stores all information in registers into a RAM 40 or other storage media except hard disks through a north bridge 35 for entering into a System Management Mode (SMM). The central processing unit 30 also sends a driving signal and an address to the north bridge 35.

Refer to step S15, after receiving the above signals, the north bridge 35 drives the RAM 40 to provide a block as a System Management RAM (SMRAM) according to the received address. Then as shown in step S16, the central processing unit 30 transmits the service program in a basic input output system in read only memory (ROM) 55 into the System Management RAM through the second bus 60, the second bus interface 65, the first bus interface 50, the first bus 45 and the north bridge 35. At last, as shown in step S17, after the service program being received by the System Management RAM, the central processing unit 30 executes the service program for initiating the multimedia player system mode.

When the central processing unit 30 has not entered the System Management Mode, the System Management RAM is used as a random access memory (RAM) for a video processing device 70 coupled with the first bus 45. However, when some data intend to be transmitted to the specific block of the RAM (System Management RAM), usually the data is transmitted and stored in a video RAM (VRAM) 75 coupled with the video processing device 70. Thus there is no data in the specific block of the RAM (System Management RAM). Therefore, when the central processing unit 30 enters the System Management Mode, the service program in a basic input output system in read only memory (ROM) 55 is transmitted to the System Management RAM.

In addition, a computer system in accordance with the present invention having a first operating system mode and a second operating system mode. The first operating system mode is system with higher system resource consumption such as Windows operating systems—Windows XP, Windows NT, Window 98, Windows 2000 and Windows Me and a installed with a plurality of application programs while the second operating system mode is an operating system with power system resource consumption such as Linux operating system. The second operating system mode shares the application programs with the first operating system mode. When users are under the first operating system mode of the computer system and would like to switch to the second operating system mode directly for reducing time of initiating application programs as well as reducing computer system resource consumption, the above interrupt technology is applied. Users only need to press buttons for sending signals to the receiving unit 15. After receiving the signal, the receiving unit 15 transmits a first signal to the south bridge 20 of the computer system. Then the south bridge 20 sends a second signal to the central processing unit 30. After receiving the second signal, the central processing unit 30 stops the current first operating system mode of the computer system and switches to execute the second operating system mode. The first signal from the receiving unit can be an interrupt request signal or a system management interrupt signal. The interrupt processes of these two signals are as above descriptions of FIG. 2 & FIG. 3.

Furthermore, when users of computer systems only want to run the multimedia program without using other application programs, the second operating system mode is directly used as the operating system mode after the computer system being turned on so that the computer system resource consumption is reduced and the efficiency of the computer system is increased. By this way, user only need to press the buttons of the remote controller 10 for sending signal to the receiving unit 15. The receiving unit 15 is driven to transmit a first signal to the south bridge 20. Then the south bridge 20 sends a second signal to the central processing unit 30 for driving the central processing unit 30 to run the service program corresponding to the second signal. Thus the second operation system mode is initiated and under this mode, the multimedia player system mode is executed. The first signal can be an interrupt request signal or a system management interrupt signal. The interrupt processes of these two signals are as above descriptions of FIG. 2 & FIG. 3.

In summary, a method for remote control of a computer system in accordance with the present invention makes users to operate the computer system such as initiation of the multimedia player system mode for playing MPEG-1 Audio Layer 3 (MP3) music, compact disk (CD), digital versatile disc (DVD), Video Compact Disc (VCD), TV programs, broadcasting or running an operating system mode with lower system resource consumption by a remote controller 10. The method of the present invention uses interrupt technology of computer systems. Thus there is no need to use a keyboard encoder for coding and a central processing unit for decoding process as a prior art of remote control technology.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A method for remote control of a computer system with an operating system mode and a multimedia player system mode comprising the steps of:
receiving a remote signal by a receiving unit in the computer system; driving the receiving unit to send a first signal to a chip unit of the computer system;
driving the chip unit to transmit a second signal to a central processing unit of the computer system; and
driving the central processing unit to initiate the multimedia player system mode.

2. The method as claimed in claim 1, wherein the chip unit is a south bridge.

3. The method as claimed in claim 1, wherein the first signal is an interrupt request signal being sent to an interrupt control unit of the chip unit for driving the interrupt control unit sending the second signal to the central processing unit; then the method further comprising the steps of:
stopping running current operation of the central processing unit and sending a third signal from the central processing unit to the interrupt control unit;
driving the interrupt control unit to send interrupt information to the central processing unit; and
receiving the interrupt information and running a service program in a random access memory of the computer system by the central processing unit according to the received interrupt information for initiating the multimedia player system mode.

4. The method as claimed in claim 3, further comprising the step of storing all information in registers on a storage medium after the central processing unit stopping execution of current programs.

5. The method as claimed in claim 3, wherein the interrupt information is data retrieved from an interrupt vector table by the interrupt control unit according to the interrupt request signal.

6. The method as claimed in claim 5, wherein the interrupt vector table contains addresses of the service programs.

7. The method as claimed in claim 1, wherein the first signal is a system management interrupt signal being sent to a power management unit of the chip unit for driving the power management unit sending the second signal to the central processing unit; then the method further comprising the steps of:
stopping current operation of the central processing unit and sending a driving signal and an address to a north bridge from the central processing unit;
driving the north bridge to make a random access memory (RAM) of the computer system provide a block as a system management random access memory (SMRAM) according to the received address; transmitting a service program to the system management random access memory; and
executing the service program and initiating the multimedia player system mode.

8. The method as claimed in claim 7, further comprising the step of storing all information in registers on a storage medium after the central processing unit stopping execution of current programs.

9. The method as claimed in claim 7, wherein the service program is previously stored in a basic input output system in read only memory (ROM) of the computer system.

10. A method for remote control of a computer system comprising the steps of:
receiving a remote signal by a receiving unit in the computer system;
driving the receiving unit to send a first signal to a chip unit of the computer system;
driving the chip unit to transmit a second signal to a central processing unit of the computer system; and
stopping a first operating system mode of the computer system to execute a second operating system mode of the computer system.

11. The method as claimed in claim 10, wherein the chip unit is a south bridge.

12. The method as claimed in claim 10, wherein the first signal is an interrupt request signal being sent to an interrupt control unit of the chip unit for driving the interrupt control unit sending the second signal to the central processing unit; then the method further comprising the steps of:
stopping running current operation of the central processing unit and sending a third signal from the central processing unit to the interrupt control unit;
driving the interrupt control unit to send interrupt information to the central processing unit; and
receiving the interrupt information and running a service program in a random access memory of the computer system by the central processing unit according to the received interrupt information for initiating the multimedia player system mode.

13. The method as claimed in claim 12, further comprising the step of storing all information in registers on a storage medium after the central processing unit stopping execution of current programs.

14. The method as claimed in claim 12, wherein the interrupt information is data retrieved from an interrupt vector table by the interrupt control unit according to the interrupt request signal.

15. The method as claimed in claim 14, wherein the interrupt vector table contains addresses of the service programs.

16. The method as claimed in claim 10, wherein the first signal is a system management interrupt signal being sent to a power management unit of the chip unit for driving the power management unit sending the second signal to the central processing unit; then the method further comprising the steps of:
stopping current operation of the central processing unit and sending a driving signal and an address to a north bridge from the central processing unit;
driving the north bridge to make a random access memory (RAM) of the computer system provide a block as a system management random access memory (SMRAM) according to the received address;
transmitting a service program to the system management random access memory; and
executing the service program and initiating the second operating system mode.

17. The method as claimed in claim 16, further comprising the step of storing all information in registers on a storage medium after the central processing unit stopping execution of current programs.

18. The method as claimed in claim 16, wherein the service program is previously stored in a basic input output system in read only memory (ROM) of the computer system.

19. The method as claimed in claim 10, wherein the first operating system mode is a Windows operating system.

20. The method as claimed in claim 10, wherein the second operating system mode is a Linux operating system.

21. A method for remote control of a computer system comprising the steps of:
providing the computer system with a first operating system mode and a second operating system mode; wherein the system resource consumption of the first operating system mode is larger than the system resource consumption of the a second operating system mode;
receiving a remote signal by a receiving unit in the computer system;
driving the receiving unit to send a first signal to a chip unit of the computer system;
driving the chip unit to transmit a second signal to a central processing unit of the computer system;
driving the central processing unit to execute a service program corresponding to the second signal;
initiating the second operating system mode; and
executing a multimedia player system mode under the second operating system mode.

22. The method as claimed in claim 21, wherein the chip unit is a south bridge.

23. The method as claimed in claim 21, wherein the first signal is an interrupt request signal being sent to an interrupt control unit of the chip unit for driving the interrupt control unit sending the second signal to the central processing unit; then the method further comprising the steps of:
stopping running current operation of the central processing unit and sending a third signal from the central processing unit to the interrupt control unit;
driving the interrupt control unit to send interrupt information to the central processing unit; and
receiving the interrupt information and running a service program in a random access memory of the computer system by the central processing unit according to the received interrupt information for initiating the multimedia player system mode.

24. The method as claimed in claim 23, further comprising the step of storing all information in registers on a storage medium after the central processing unit stopping execution of current programs.

25. The method as claimed in claim 23, wherein the interrupt information is data retrieved from an interrupt vector table by the interrupt control unit according to the interrupt request signal.

26. The method as claimed in claim 25, wherein the interrupt vector table contains addresses of the service programs.

27. The method as claimed in claim 21, wherein the first signal is a system management interrupt signal being sent to a power management unit of the chip unit for driving the power management unit sending the second signal to the central processing unit; then the method further comprising the steps of:
stopping current operation of the central processing unit and sending a driving signal and an address to a north bridge from the central processing unit;
driving the north bridge to make a random access memory (RAM) of the computer system provide a block as a system management random access memory (SMRAM) according to the received address;
transmitting a service program to the system management random access memory; and
executing the service program and initiating the second operating system to run the multimedia player system mode.

28. The method as claimed in claim 27, further comprising the step of storing all information in registers on a storage medium after the central processing unit stopping execution of current programs.

29. The method as claimed in claim 27, wherein the service program is previously stored in a basic input output system in read only memory (ROM) of the computer system.

30. The method as claimed in claim 21, wherein the first operating system mode is a Windows operating system.

31. The method as claimed in claim 21, wherein the second operating system mode is a Linux operating system.
